(19) United States
(12) Patent Application Publication
(10) Pub. No.: US 2011/0226081 A1
(43) Pub. Date: Sep. 22, 2011

(54) CONTROL CABLE

(75) Inventors: Takaaki Hayashida, Nagoya-shi (JP); Yoshio Misaki, Nagoya-shi (JP); Naoyuki Mori, Nagoya-shi (JP)

(73) Assignee: CHUO HATSUJO KABUSHIKI KAISHA, Nagoya-shi (JP)

(21) Appl. No.: 13/048,788

(22) Filed: Mar. 15, 2011

(30) Foreign Application Priority Data
Mar. 18, 2010 (JP) 2010-062802

(51) Int. Cl. F16C 1/10

(52) U.S. Cl. 74/500.5

(57) ABSTRACT

A control cable 10 for an automotive application comprises an outer cable 14, an inner cable 12, and a foam member 16. The outer cable 14 includes an inner hollow. The inner cable 12 is slidably disposed within the inner hollow of the outer cable 14. The foam member 16 is bonded to an outer surface of the outer cable 14. The foam member 16 includes a foam material and is molded onto the outer surface of the outer cable 14.

### CROSS-REFERENCE TO RELATED APPLICATION

This application claims priority to Japanese Patent Application No. 2010-62802, filed on Mar. 18, 2010, the contents of which are hereby incorporated by reference into the present application.

### TECHNICAL FIELD

The present application generally relates to a control cable suitable for automotive applications, such as a control cable for locking and unlocking an automobile door, a hinged gas cap cover/lid, a reclining seat, an engine lid, or a trunk lid.

### DESCRIPTION OF RELATED ART

In a vehicle (e.g., an automobile, a motorcycle, or an industrial vehicle such as a forklift), an input device and an output device may be disposed at positions separated from each other and input to the input device may be transferred to the output device via a control cable. Such a control cable includes an outer cable and an inner cable slidably inserted into the outer cable. Due to an advancing/retreating movement of the inner cable in the outer cable, the input to the input device is transferred to the output device. A conventional example of such a control cable is disclosed in Japanese Patent Application Publication No. 2001-124047.

### SUMMARY

Some control cables for automotive applications are arranged in a relatively confined space such as inside a door panel or a floor panel. With such a control cable, a hammering noise is sometimes generated due to the control cable striking another member (such as the door panel or the floor panel). Therefore, in order to prevent the hammering noise, a control cable for automotive applications in which a foam member is provided on an outer circumferential surface of the outer cable is being developed.

A conceivable method of mounting the foam member to the outer cable involves separately forming the outer cable and the foam member, and bonding the foam member to the outer cable using an adhesive. Specifically, a piece of cylindrical foam member is formed by performing die cutting on a sheet material (e.g., a urethane sheet) formed of foamable resin, and the piece of cylindrical foam member is bonded to the outer circumferential surface of the outer cable using the adhesive. However, since such a method involves producing the foam member by die cutting a sheet material, a restriction arises in shapes of the foam member that can be produced. For example, since there is a limit to a thickness of the sheet material on which the die cutting can be performed, a length in an axial direction of the foam member is restricted. In addition, since the foam member must be bonded to the outer cable using the adhesive, sufficient bonding strength cannot be obtained if the length in the axial direction of the foam member is too short. Furthermore, since the foam member is formed by punching the sheet material, unnecessary portions of the sheet material must be discarded. Moreover, since the foam member is bonded to the outer cable using the adhesive, the bonding operation may be troublesome.

It is an object of the present teachings to provide a control cable for an automotive application having a foam member provided on an outer circumferential surface of an outer cable, capable of improving a degree of freedom of shape of the foam member while preventing foam material that must be discarded from being produced, and enabling the foam member to be fixed to the outer cable without having to perform troublesome operations.

In one aspect of the present teachings, a control cable for an automotive application comprises an outer cable, an inner cable, and a foam member. The outer cable includes an inner hollow. The inner cable is slidably disposed within the inner hollow of the outer cable. The foam member includes a foam material. Preferably, the foam member is molded onto an outer circumferential surface of the outer cable, whereby the foam member is bonded to the outer surface of the outer cable.

The above control cable bonds the foam member to the outer circumferential surface of the outer cable by molding the foam member on the outer circumferential surface of the outer cable. Therefore, a degree of freedom of shape of the foam member can be improved, wasteful foam material can be prevented from being produced, and the foam member can be bonded to the outer cable without having to perform troublesome operations.

Other objects, features and advantages of the present teachings will be readily understood after reading the following detailed description together with the accompanying drawings and claims. Of course, the additional features and aspects disclosed herein may be utilized singularly or, in combination with the above-described aspect and features.

### BRIEF DESCRIPTION OF DRAWINGS

FIG. 1 is a diagram illustrating a schematic configuration of a control cable according to a representative embodiment of the present teachings.

FIG. 2 is a cross section taken along II-II in FIG. 1.

FIG. 3 is an enlarged view of a boundary region between a foam member and an outer cable in FIG. 2.

FIG. 4 is a diagram illustrating a schematic configuration of a mold for manufacturing the control cable according to a representative embodiment of the present teachings.

FIG. 5 is a diagram illustrating a state during a foam member molding.

FIG. 6 is a diagram illustrating a control cable according to a modification.

FIG. 7 is a diagram illustrating a control cable according to another modification.

FIG. 8 is a diagram illustrating a control cable according to yet another modification.

FIG. 9 is a graph illustrating a relationship between composition ratio and rigidity of a foam member.

FIG. 10 is a graph illustrating a relationship between composition ratio and bonding strength of a foam member.

### DETAILED DESCRIPTION OF A PREFERRED EMBODIMENT

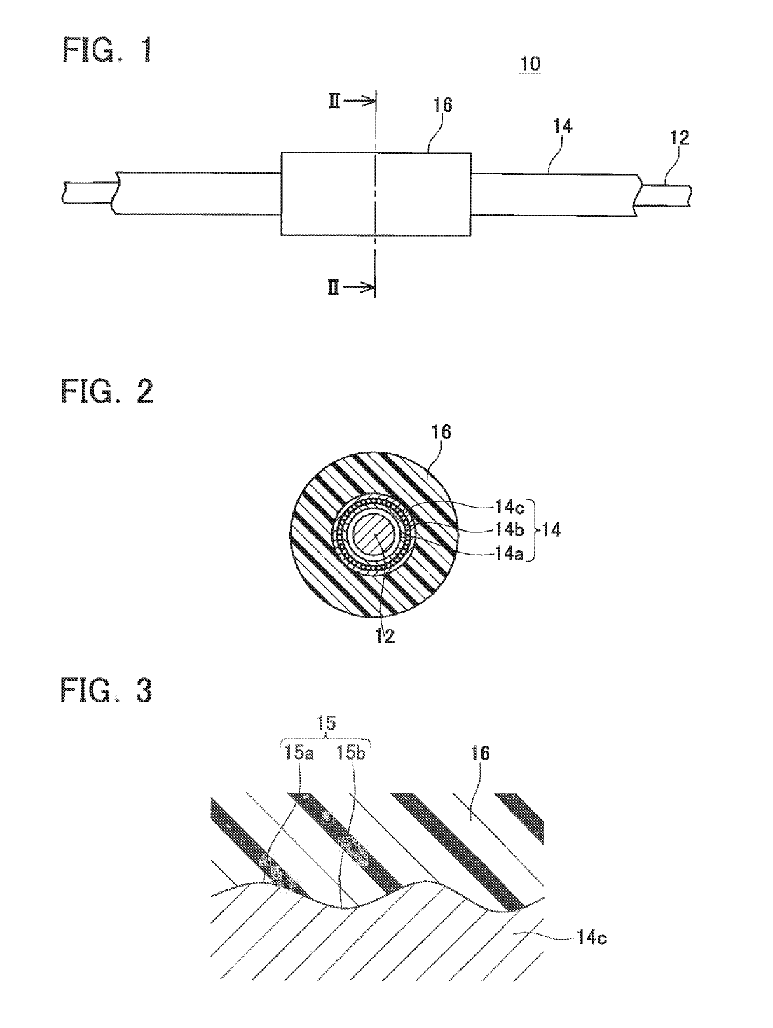

A control cable according to a representative embodiment of the present teachings will now be described. As shown in FIGS. 1 and 2, a control cable 10 comprises an inner cable 12, an outer cable 14 into which the inner cable 12 is slidably inserted, and a foam member 16 provided on an outer circumferential surface of the outer cable 14.

The inner cable 12 comprises a single metal wire. A hard steel wire, a stainless steel wire, an oil-tempered wire (e.g., SWO-A, SWO-B, or SWOSC-V), and a bluing wire may be used as a material of the inner cable 12. Zinc galvanizing may be applied on a surface of the inner cable 12. Mounting parts (not shown) may respectively be provided at both ends of the inner cable 12, whereby one end can be arranged so as to be mountable to an input device and the other end can be arranged so as to be mountable to an output device. Moreover, in addition to the configuration described above, various known configurations may be adopted for the inner cable. For example, a twisted wire structure may be adopted in which a plurality of steel wires is twisted together.

The outer cable 14 has a trilaminar structure that is configured such that an innermost layer is a resin liner 14a, an intermediate layer is a strand 14b, and an outermost layer is an outer coat 14c. The liner 14a is formed in a tubular shape by a resin material such as polyethylene (PE), polytetrafluoroethylene (PTFE), and polybutylene terephthalate (PBT). The strand 14b comprises a plurality of metal wires tightly twisted together in a helical fashion around the liner 14a. The outer coat 14c that covers an outer circumference of the strand 14b is formed by polypropylene (PP), polyethylene (PE), or polyamide (PA).

The foam member 16 is molded onto an outer circumferential surface of the outer coat 14c. Therefore, the foam member 16 is bonded to the outer circumferential surface of the outer coat 14c, and is integrated with the outer cable 14 thereby. The foam member 16 is formed in a cylindrical shape that extends in an axial direction of the outer cable 14. The foam member 16 is bonded to an entire contacting surface of the outer coat 14c by a bonding force of the foam member 16 itself. Specifically, as shown in FIG. 3, the contacting surface 15 of the outer coat 14c has a wavy surface formed by heat of molding of the foam member 16, and includes convex portions 15a and concave portions 15b. The foam member 16 is bonded to both surfaces of the convex portions 15a and concave portions 15b (i.e., the entire contacting surface 15 of the outer coat 14c).

A resin material with cushioning characteristics (e.g., urethane foam) may be used as a material of the foam member 16. When using the urethane foam as the material of the foam member 16, both a one-component type having polyol and isocyanate housed in a single container and a two-component type having polyol and isocyanate housed in separate containers can be used. When using the one-component type urethane foam, polyol and isocyanate housed in the container can be sprayed into a mold to have polyol and isocyanate react with each other. On the other hand, when using the two-component type urethane foam, polyol and isocyanate respectively housed in separate containers can be combined and agitated in a mold to have polyol and isocyanate react with each other.

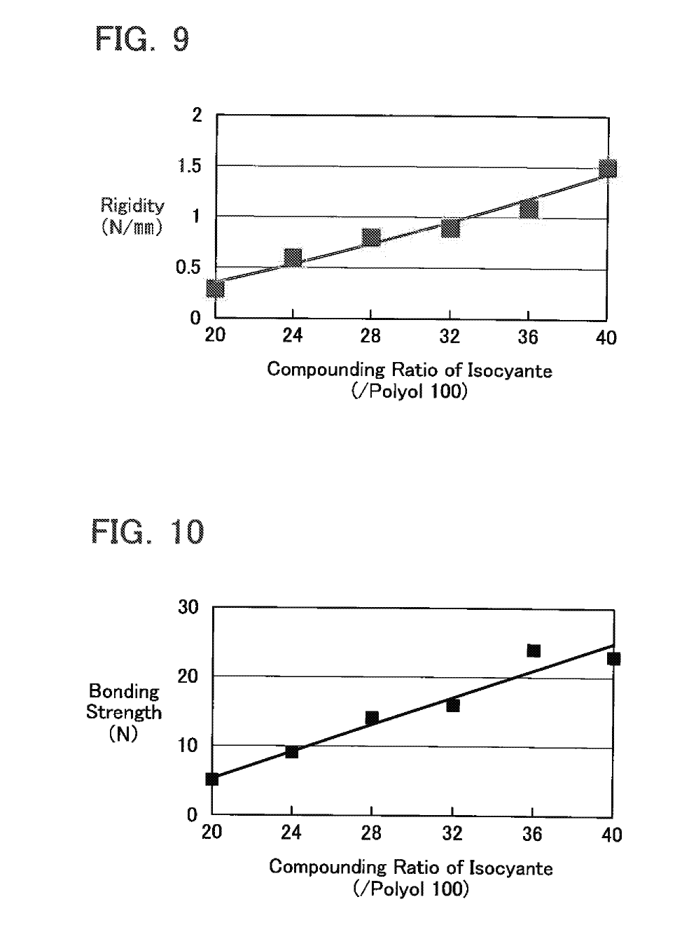

Mechanical characteristics of the foam member 16 can be adjusted by varying a compounding ratio of polyol and isocyanate. For example, as shown in FIG. 9, a rigidity of the foam member 16 can be increased by increasing a compounding ratio of isocyanate with respect to polyol. Therefore, depending on a function required for the foam member 16, a desired rigidity can be obtained by varying the compounding ratio of polyol and isocyanate. For example, when using the foam member 16 for positioning of the control cable 10, the rigidity of the foam member 16 is increased by increasing the compounding ratio of isocyanate with respect to polyol. Accordingly, deformation of the foam member 16 can be suppressed and the control cable 10 can be positioned to a desired position with high accuracy.

In addition, a bonding strength of the foam member 16 to the outer cable 14 can also be adjusted by varying the compounding ratio of polyol and isocyanate. Specifically, as shown in FIG. 10, the bonding strength of the foam member 16 can be increased by increasing the compounding ratio of isocyanate with respect to polyol. Therefore, depending on a magnitude of an external force to be acted upon the foam member 16, an appropriate bonding force can be arranged to act between the foam member 16 and the outer cable 14 by adjusting the compounding ratio of polyol and isocyanate.

Next, a method for manufacturing the control cable 10 will be described. Among the method for manufacturing the control cable 10, since processes for manufacturing the inner cable 12 and the outer cable 14 can be implemented similar to the conventional processes, a detailed description of the processes will be omitted herein. A process of molding the foam member 16 will now be described in detail.

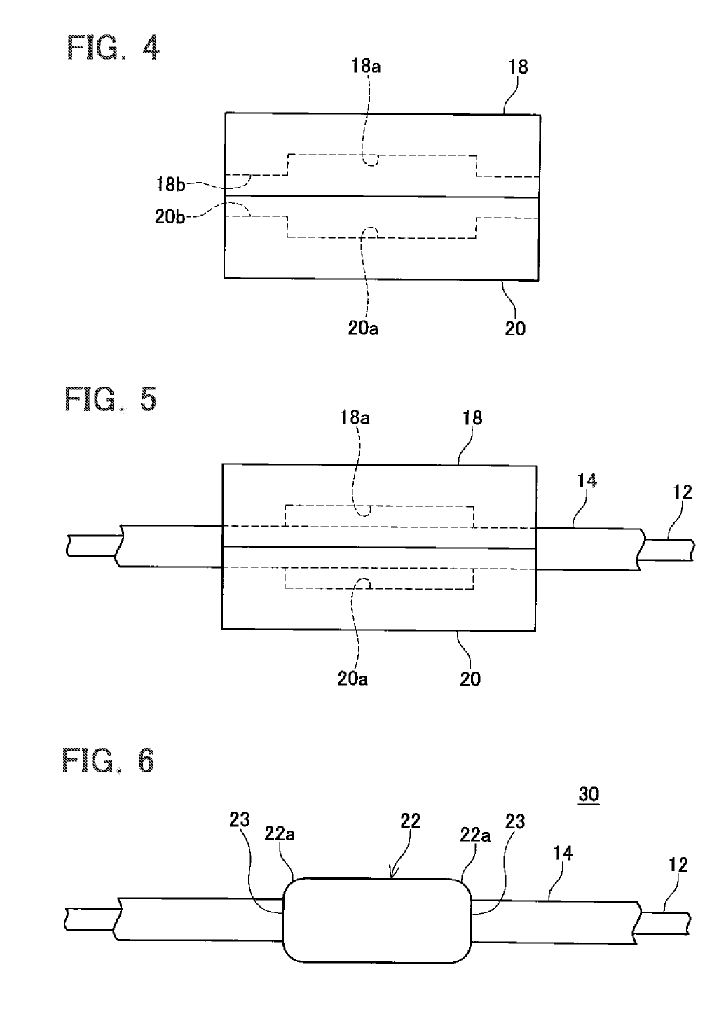

To mold the foam member 16, a mold (18, 20) as shown in FIG. 4 is used. The mold (18, 20) includes a first mold 18 and a second mold 20. A molded surface 18a, and a groove 18b conforming to a shape of the outer cable 14, are formed on the first mold 18. A molded surface 20a, and a groove 20b conforming to a shape of the outer cable 14, are formed on the second mold 20. When the first mold 18 is closed by the second mold 20, a cavity conforming to a shape of the foam member 16 is formed by the molded surfaces 18a, 20a and a through hole conforming to a shape of the outer cable 14 is formed by the grooves 18b, 20b.

When molding the foam member 16, the outer cable 14 is to be inserted into the molds (18, 20) (in other words, insert molding is performed). Specifically, as shown in FIG. 5, the outer cable 14 is disposed so that the outer cable 14 penetrates the molds (18, 20). In other words, the outer cable 14 is disposed so as to penetrate both the through hole formed by the grooves 18b, 20b and the cavity formed by the molded surfaces 18a, 20a. Positions of the outer cable 14 and the molds (18, 20) are adjusted according to a position where the foam member 16 is to be formed. Next, raw material of the foam member 16 is introduced into the molds (18, 20). For example, polyol and isocyanate are introduced. Accordingly, the foam member 16 is molded inside the molds (18, 20), and the foam member 16 bonds to the outer cable 14 by the bonding force of the foam member 16 itself. After the molding of the foam member 16 is completed, the control cable 10 is removed from the mold (18, 20). Consequently, the control cable 10 is manufactured thereby.

The control cable 10 described above is arranged in a relatively confined space such as inside a door panel or a floor panel. Therefore, when the control cable 10 is being arranged, an end surface of the foam member 16 comes into contact with an inner wall surface of the door panel or the floor panel and, as a result, a force that works to peel the foam member 16 off from the outer cable 14 acts on the foam member 16. With the control cable 10 according to the representative embodiment, since the foam member 16 is bonded to the entire contacting surface 15 of the outer cable 14, the foam member 16 can be suitably prevented from detaching (being peeled off) from the outer cable 14. Moreover, after arranging the control cable 10 inside the door panel or the like is completed, the outer cable 14 can be prevented from directly striking the wall surface of the door panel or the like. Accordingly, a generation of hammering noise, as well as a transfer of an impact to the control cable 10, can be suppressed.

As described in detail above, with the control cable 10 according to the representative embodiment, since the foam member 16 is molded onto an outer circumferential surface of the outer cable 14, degrees of freedom of sizes and shapes of the foam member 16 can be increased. Accordingly, the foam member 16 can be designed in an appropriate size and shape depending on an intended usage of the foam member 16. In addition, since the foam member 16 is molded, the foam raw material to be discarded can be reduced, and yield thereof can be improved. Furthermore, since the foam member 16 is bonded to the outer cable 14 by the bonding force of the foam member 16 itself, operations such as bonding the foam member to the outer cable using an adhesive are no longer necessary.

The preferred embodiment of the present teachings has been described above, however, the explanation was given merely as an example. The present teachings is not limited to this type of configuration.

For example, as in a case of a control cable 30 shown in FIG. 6, a foam member 22 bonded to the outer circumferential surface of the outer cable 14 preferably has peripheral edges 22a of end surfaces 23 of the foam member 22 chamfered. When the peripheral edges 22a of the end surfaces 23 of the foam member 22 are chamfered, the end surfaces 23 of the foam member 22 are less likely to become caught by other members when the control cable 30 is being arranged. Accordingly, a large peeling force can be prevented from acting on the foam member 22 and the arranging operation in the confined space can be easily performed. Note that a linear chamfering (a chamfering at a predetermined angle relative to a side surface of the foam member 22) may be performed at a predetermined angle, or alternatively, a round chamfering may be performed.

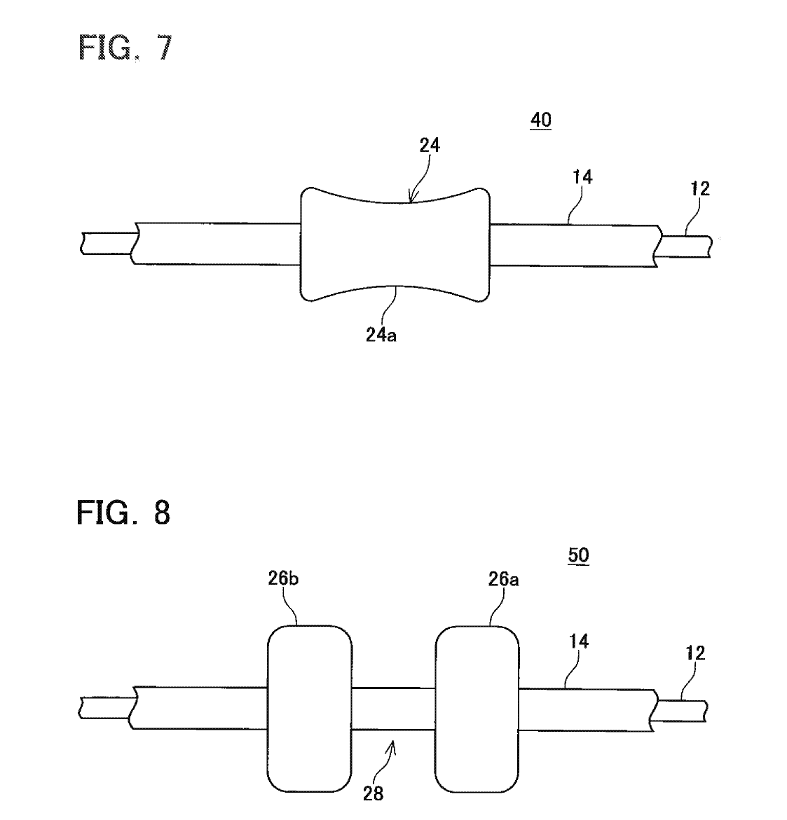

Furthermore, the shape of the foam member is not limited to the cylindrical shape described above; alternatively, an arbitrary shape may be adopted. For example, as in a case of a control cable 40 shown in FIG. 7, a foam member 24 including a constricted portion between its end surfaces may be adopted. That is, the diameter of the constricted portion may be smaller than a diameter of the end surface, so as to be fit with a shape of a member to make contact therewith. By conforming the shape of an outer circumferential surface 24a of the foam member 24 to another member (e.g., the door panel, the floor panel, or the like), interference between the foam member 24 and the other member (e.g., the door panel, the floor panel, or the like) can be suitably prevented.

Moreover, a configuration of a control cable 50 shown in FIG. 8 may be adopted. With the control cable 50, a first foam member 26a and a second foam member 26b are provided on the outer circumferential surface of the outer cable 14. A gap corresponding to a clamping member that clamps the outer cable 14 is provided between the first foam member 26a and the second foam member 26b. According to such a configuration, a position of the clamping member with respect to the outer cable 14 is prevented from varying by the first foam member 26a and the second foam member 26b. Consequently, the outer cable 14 is clamped (in other words, positioned) accurately and a routing path of the control cable can be set to a desired path.

Finally, although the preferred representative embodiments have been described in detail, the present embodiments are for illustrative purpose only and not restrictive. It is to be understood that various changes and modifications may be made without departing from the spirit or scope of the appended claims. In addition, the additional features and aspects disclosed herein also may be utilized singularly or in combination with the above aspects and features.

What is claimed is:

1. A control cable for an automotive application comprising:
an outer cable including an inner hollow;
an inner cable slidably disposed within the inner hollow; and
a foam member bonded to an outer surface of the outer cable, wherein the foam member includes a foam material and is molded onto the outer surface of the outer cable.

2. The control cable as in claim 1, wherein the foam member is bonded to the outer surface of the outer cable by a bonding force of the foam member itself.

3. The control cable as in claim 2, wherein the foam material is urethane foam.

4. The control cable as in claim 3, wherein the foam member has a tubular shape extending in an axial direction of the outer cable, and both peripheral edges of end surfaces of the foam member are chamfered.

5. The control cable as in claim 4, wherein the control cable includes a first foam member bonded to the outer surface of the outer cable, and a second foam member bonded to the outer surface of the outer cable, and both of the first and second foam members include the foam material and are molded onto the outer surface of the outer cable, and
a space for a clamping member clamping the outer cable is provided between the first and second foam members.

6. The control cable as in claim 5, wherein the outer cable comprises an outer coat made of polypropylene, polyethylene, or polyamide,
the outer coat is disposed outermost of the outer cable, and
the foam member is bonded to an outer surface of the outer coat.

7. The control cable as in claim 6, wherein the outer cable further comprises a tubular liner disposed innermost of the outer cable, and an intermediate layer disposed between the resin liner and the outer coat, and
the intermediate layer comprises a plurality of metal wires twisted around the liner.

8. The control cable as in claim 7, wherein the inner cable consists of a single metal wire, and a surface of the metal wire is plated by Zn.

9. The control cable as in claim 3, wherein the foam member has a tubular shape extending in an axial direction of the outer cable, and includes a constricted portion between its end surfaces, the constricted portion having a smaller diameter than a diameter of the end surface.

10. The control cable as in claim 1, wherein the foam member has a tubular shape extending in an axial direction of the outer cable, and both peripheral edges of end surfaces of the foam member are chamfered.

11. The control cable as in claim 1, wherein the control cable includes a first foam member bonded to the outer surface of the outer cable, and a second foam member bonded to the outer surface of the outer cable, and both of the first and second foam members include the foam material and are molded onto the outer surface of the outer cable, and
a space for a clamping member clamping the outer cable is provided between the first and second foam members.

12. The control cable as in claim 1, wherein the foam member has a tubular shape extending in an axial direction of the outer cable, and includes a constricted portion between its end surfaces, the constricted portion having a smaller diameter than a diameter of the end surface.

13. A control cable for an automotive application comprising:
an outer cable including an inner hollow;
an inner cable slidably disposed within the inner hollow; and
a foam member bonded to an outer surface of the outer cable,
wherein
the foam member includes a foam material,
the outer surface of the outer cable includes a contacting surface to which the foam member is bonded, and
the contacting surface comprises convex portions and concave portions.

14. The control cable as in claim 13, wherein the foam member is bonded to entire surfaces of both the convex portions and concave portions.

15. The control cable as in claim 14, wherein the foam member is bonded to the outer surface of the outer cable by a bonding force of the foam member itself.

16. The control cable as in claim 15, wherein the foam material is urethane foam.

17. A control cable for an automotive application comprising:
an outer cable including an inner hollow;
an inner cable slidably disposed within the inner hollow;
a first foam member bonded to an outer surface of the outer cable; and
a second foam member bonded to the outer surface of the outer cable,
wherein
both of the first and second foam members include a foam material, and
a space for a clamping member clamping the outer cable is provided between the first and second foam members.
